(19) United States
(12) Patent Application Publication
(10) Pub. No.: US 2026/0354943 A1
(43) Pub. Date: Nov. 12, 2026

(54) IMPLANT RETAINED OVERDENTURE ATTACHMENT WITH A SLOT SYSTEM

(71) Applicant: Ajman University, AJman (AE)

(72) Inventors: Vinay Sivaswamy, Ajman (AE); Vijay Bhavrao Desai, Ajman (AE)

(73) Assignee: Ajman University, Ajman (AE)

(21) Appl. No.: 19/201,867

(22) Filed: May 7, 2025

(51) Int. Cl. A61C 8/00

(52) U.S. Cl. CPC A61C 8/0065; A61C 8/0057

(57) ABSTRACT

The apparatus includes an overdenture attachment system. The overdenture attachment has a broad projection over a narrow stem atop an implant abutment. The overdenture attachment has a transverse slot over the surface. A gasket will provide retention around the narrow stem. An open ring housing will contain the gasket and will be embedded in the overdenture.

### BACKGROUND

Overdentures are a type of removable denture that can replace missing teeth and are supported by natural teeth, dental implants, or tooth roots. Overdentures are retained by components called “Attachments” which need to be secured in remaining teeth or in dental implants. These Attachments retain the overdenture prostheses inside the oral cavity and prevent them from getting dislodged during function. Presently, there are very few attachments available that provide an efficient low-profile solution for overdentures.

### BRIEF DESCRIPTION OF DRAWINGS

FIG. 1 is an example perspective view of an overdenture attachment system;

FIG. 2 is another example perspective view of an overdenture attachment system;

FIG. 3 is another example perspective view of an overdenture attachment system;

FIG. 4 is an example perspective view of overdenture attachment gasket;

FIG. 5 is an example perspective view of overdenture attachment housing

### DETAILED DESCRIPTION OF PREFERRED EMBODIMENTS

The following detailed description refers to the accompanying drawings. The same reference numbers in different drawings may identify same or similar elements.

Systems, devices, and/or methods described herein are for implant retained overdenture attachments. In embodiments, the described implant retained overdenture attachment provides for a low-profile solution for overdentures.

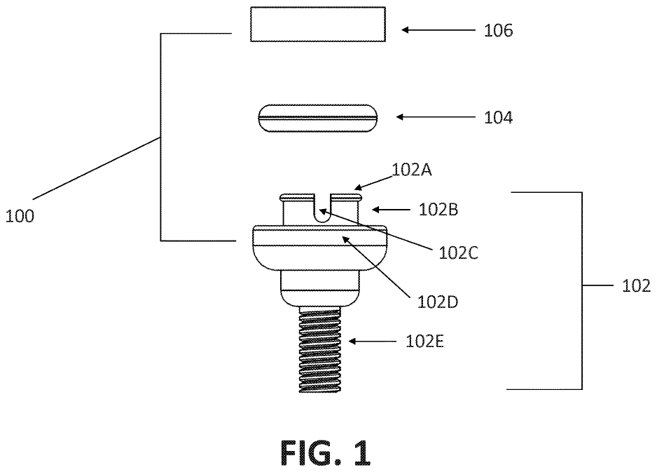

FIG. 1 shows overdenture attachment 100. This innovation utilizes a combination of a flat rounded projection 102A supported by a narrower diameter stem 102B on top of an implant abutment. As shown in FIGS. 1, 102A and 102B will have a transverse slot 102C across a horizontal plane. As shown in FIG. 1, a hard rubber gasket 104 corresponding to the diameter of the narrower stem will slip over the broader projection thereby providing retention. As shown in FIG. 1, the gasket will be housed in an open ring stainless steel housing 106. The housing and gasket assembly will be embedded in the tissue surface of the overdenture. The overdenture attachment abutment will be secured directly to the implant platform. In embodiments, screw portion 102E will be the primary mode of anchorage into the implant platform.

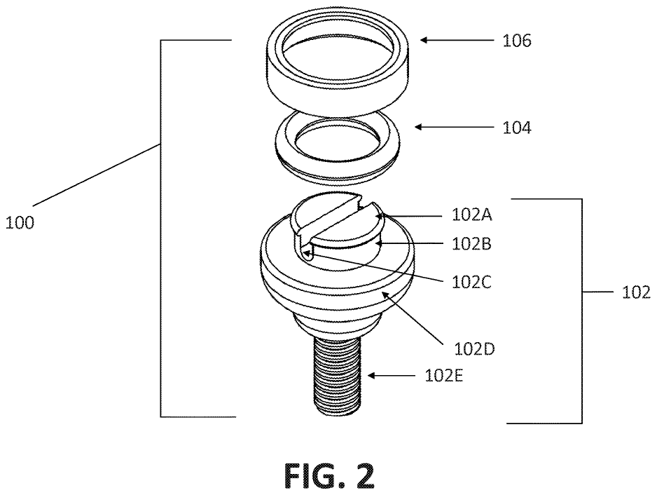

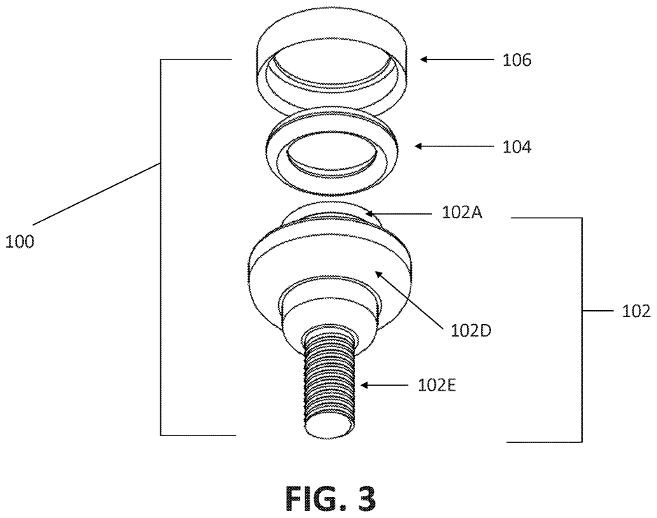

FIG. 1 describes overdenture attachment 100 with a side perspective view of the overdenture attachment system with gasket and housing. FIGS. 2 and 3 further describes overdenture attachment 100 with isometric perspective views of the attachment unit along with the gasket and housing.

As shown in FIG. 2, overdenture attachment 102 has a flat rounded projection 102A supported by a narrow diameter stem 102B positioned on top of an implant abutment 102D. Both 102A and B have a horizontal slot over their surface 102C. In embodiments, the flat rounded projection 102A may have a diameter of 2.75 mm to 3.25 mm. In embodiments, the height of 102A may range from 1 mm to 1.75 mm. In embodiments, stem 102B may have a diameter of 2.5 mm to 3 mm and the height may be 1.5 mm to 1.75 mm. In embodiments, slot 102C may have a diameter of 1 mm to 1.25 mm depending on the width of the implant used and the depth of the slot 102C may range from 0.75 to 1 mm. The implant abutment 102D may have a diameter of 3.75 to 6 mm depending on the implant system. The height of 102D may range from 2.5 mm to 6 mm depending on the thickness of the gingival tissue.

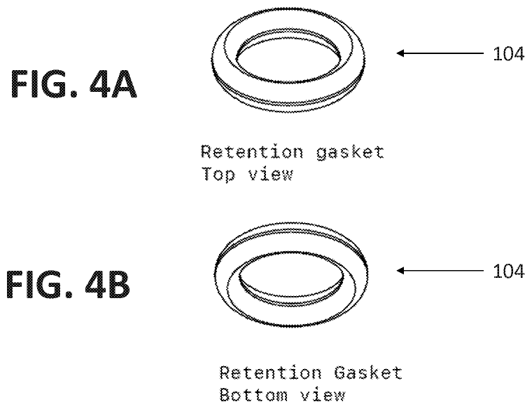

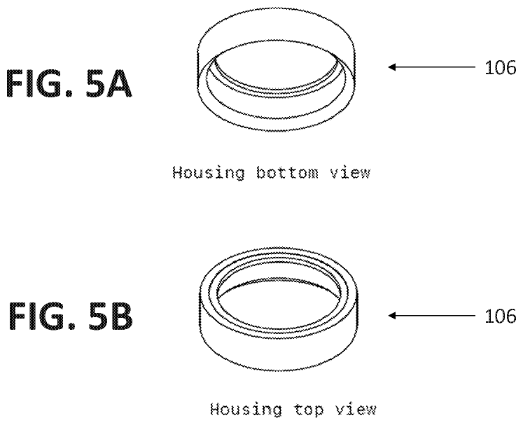

FIG. 4 shows perspective isometric top and bottom views of overdenture attachment gasket 104. In embodiments, the diameter of the inner hole of the gasket 104 may be 2.5 mm to 3 mm. In embodiments, the thickness of the gasket may be 1.5 mm to 1.75 mm. The gasket 104 may be fabricated from silicone material to impart high flexibility and elasticity. The gasket 104 may be modified to feature reversed projections on the outer sides to impart self-retentive capability. FIG. 5 shows perspective isometric top and bottom views of overdenture attachment housing 106. In embodiments, the diameter of the housing may be 3.75 mm to 4.5 mm. The housing 106 features a circular opening on the surface which has a diameter of 2 mm to 3 mm. The housing 106 may be modified to feature reversed ridges to retain the gasket 104. The housing 106 may also be modified to feature ridges on the outer sides to enable retention to the overdenture tissue surface.

In embodiments, 102A, 102B, 102C and the open ring housing 106 provides a low-profile solution for overdentures. In embodiments, the shape of the male portion (slotted projection with narrow stem) of the attachment and the shape of the female portion (open metal housing 106) will be unique to this innovation and is a differentiating feature from commercial attachment systems.

In embodiments, the described apparatus provides a low-profile attachment solution for overdentures in the lower arch. The retention system is simple and does not contain any movable parts and is estimated to reduce wear of the connecting male and female components. Wear is estimated to be minimal due to the dimensions of slot 102C.

In embodiments, the slot will compress during insertion and removal of the attachment with a resultant reduction in friction dependent wear of the gasket over a period of clinical usage. Since it is designed to feature a low-profile (low height of the entire attachment apparatus 102A, 102B, 102C) this attachment system can be used in cases of reduced inter-arch space. In embodiments, the overdenture is easy to adapt with no requirement to learn a new system or method, and is estimated to provide improved retention for implant retained overdentures. The improved retention is derived by the gasket engaging the undercut of the narrow stem 102B. In embodiments, the broader projection 102A prevents immediate vertical displacement of the gasket 104. Since the gasket 104 is fabricated from silicone (or a similar material), gradual vertical force will aid in displacing the overdenture away from the attachment in case of removal.

In embodiments, the attachment system 102 can be adapted for tooth supported overdenture cases by replacing the implant abutment 102D and 102E with a radicular post (tapered cylinder designed to engage a prepared root canal). This modification can be made of either castable resin for custom fabrication or with metal as a prefabricated attachment system.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An apparatus, comprising:
a flat rounded projection;
an implant abutment;
a stem, wherein a bottom surface of the stem is attached to a top surface of the implant abutment, and wherein:
the top of the stem is attached to the bottom of the flat rounded projection, and
the top surface of the implant abutment is a flat surface;
a gasket that is configured for placement onto the top surface of the implant abutment, wherein the implant abutment diameter is greater than the stem diameter; and
a housing that is configured with an open surface, wherein the housing encloses the gasket, such that the flat rounded projection is visible when the flat rounded projection and the implant abutment is assembled with the gasket and the housing, and is viewed from the top of the flat rounded projection, and wherein:
the housing diameter is greater than the gasket diameter,
the housing is placed onto the top surface of the implant abutment, and
the housing includes reversed ridges which are configured to retain the gasket in place on the implant abutment.

2. The apparatus of claim 1, wherein the apparatus is configured to be fixed to an implant body directly.

3. The apparatus of claim 1, wherein the apparatus is configured to provide retention to overdentures.

4. The apparatus of claim 1, will provide retention by slipping the housing-gasket assembly on the attachment.

5. The apparatus of claim 1, further comprising:
a slot over the open surface of the flat rounded projection, wherein the slot provides a grove within the flat rounded projection and the diameter stem, wherein the slot traverse across the flat rounded projection and the slot's groove depth ranges from 0.75 to 1 mm.

6. The apparatus of claim 1, wherein the apparatus is configured to provide retention in any kind of overdenture, wherein the any kind of overdenture is a removable denture that replaces missing teeth and supported by natural teeth, dental implants, or tooth roots.

7. The apparatus of claim 1, wherein the apparatus is configured to reduce wear of the gasket by allowing compression of the attachment apparatus during insertion and removal of overdentures.

8. The apparatus of claim 5, wherein the slot compresses during insertion or removal of the apparatus from a person's mouth.

9. The apparatus of claim 1, wherein the apparatus is installed in a reduced inter-arch space in a person's mouth.

10. The apparatus of claim 1, wherein a first diameter of the housing is 3.75 mm to 4.5 mm and a circular opening diameter of the housing is 2 mm to 3 mm.

11. The apparatus of claim 1, wherein:
the flat rounded project has a first height of 1 mm to 1.75 mm,
the stem has a second height of 1.5 mm to 1.75 mm, and
the implant abutment has a third height of 2.5 mm to 6 mm.

12. The apparatus of claim 1, wherein:
the implant abutment has a first diameter of 3.75 mm to 6 mm, and
the flat rounded projection has a second diameter of 2.75 mm to 3.25 mm.
